(19) United States
(12) Patent Application Publication
(10) Pub. No.: US 2003/0118198 A1
(43) Pub. Date: Jun. 26, 2003

(54) Biaxial parametric speaker

(75) Inventors: James J. Croft III, Poway, CA (US); Vaughn W. North, Salt Lake City, UT (US)

Correspondence Address: Vaughn W. North, THORPE, NORTH & WESTERN, L.L.P., P.O. Box 1219, Sandy, UT, 84091-1219, US

(73) Assignee: American Technology Corporation

(21) Appl. No.: 10/293,203

(22) Filed: Nov. 12, 2002

Related U.S. Application Data
(63) Continuation-in-part of application No. 09/159,443, filed on Sep. 24, 1998, now Pat. No. 6,229,899.
(63) Continuation-in-part of application No. 09/850,523, filed on May 7, 2001.
(63) Continuation-in-part of application No. 09/478,114, filed on Jan. 4, 2000.
(63) Continuation-in-part of application No. 09/787,972, filed on Jan. 17, 2002.
(63) Continuation-in-part of application No. 09/430,801, filed on Oct. 29, 1999.
(60) Provisional application No. 60/338,156, filed on Nov. 12, 2001.

(51) Int. Cl. H04B 3/00; H04B 5/00

(52) U.S. Cl. 381/77; 381/79; 381/387

(57) ABSTRACT

A biaxial parametric speaker having at least two different axes of sound propagation. The speaker includes a first parametric emitter including an ultrasonic emitter surface having a primary direction of propagation along a first orientation and a second parametric emitter including an ultrasonic emitter surface having a primary direction of propagation along a second orientation. The first parametric emitter is physically coupled to the second parametric emitter such that the first and second orientations do not coincide, thereby providing for relative angular displacement of the respective first and second orientations of propagation. Electronic contacts are attached to the respective first and second parametric emitters for coupling to a parametric signal source capable of generating parametric emissions from the respective emitters which decouple in air to generate audio output along each of the respective first and second orientations.

The present invention is a continuation-in-part of U.S. Pat. No. 6,229,899 issued May 8, 2001 (T3941.CIP); U.S. patent application Ser. No. 09/850,523 filed May 7, 2001 (T3941.CIP2); U.S. patent application Ser. No. 09/478,114 filed Jan. 4, 2000 (T4855.CIP); U.S. patent application Ser. No. 09/787,972 filed Jan. 17, 2002 (T7029.CIP.PCT.US); U.S. patent application Ser. No. 09/430,801 filed Oct. 29, 1999 (T8319); and U.S. patent application Ser. No. 60/338,156 filed Nov. 12, 2001 (20028.PROV).

### BACKGROUND OF THE INVENTION

1. Field of the Invention.

The present invention relates to sound systems, and more particularly to sound systems which utilize a parametric sound source to generate a virtual speaker from a reflecting surface.

2. Related Art.

Surround sound audio systems continue to gain greater popularity as a next step beyond the previous focus on stereophonic reproduction with high fidelity. This is due in part to the desire for changing directionality of sound source as part of the listening experience. Movement of sound within a listening area provides enhanced enjoyment to corresponding movements within a music performance, and in particular, with respect to coordinated audio and visual movements as part of a movie presentation.

In order to implement an effective surround sound experience as described above, conventional sound systems may include many speakers, positioned around a room perimeter, including side walls, floor and ceiling positions. Typically, low range woofers are located at the front of the room, or under the floor, but could be positioned at any location, even in a concealed position behind the audience. With high range frequencies, the directional aspect of sound propagation is more noticeable. Tweeters, for example, can readily be detected as to source or orientation. Surround sound systems supply these higher frequencies from smaller speakers which are dispersed at the sides and back of the room, enabling their directional properties to simulate sound emanating from multiple orientations as if in a natural environment. Physical displacement and positioning at wall and ceiling locations are facilitated by the smaller size of this speaker component.

Parametric speakers are also known for their highly directional character. U.S. Pat. No. 4,823,908 of Tanaka et al. discloses that the derivation of audio output from a modulated ultrasonic carrier provides a more focused directivity, even when supplying audio at lower frequency ranges. FIG. 2 of this patent shows a conventional parametric system 8 oriented directly toward a listener 9. Acoustic filters 10 and 20 are applied along the audio path between the emitter and listener for substantially eliminating the ultrasonic component of the parametric output. Although reflective plates 19 are disclosed in Tanaka et al. (i.e. FIG. 16), their sole purpose appears to be for lengthening the acoustic path and changing the direction of propagation of the ultrasonic and/or audio frequencies. Accordingly, prior art teachings with respect to parametric speakers do not distinguish any significant difference between audio output between direct projection of parametric output toward a listener and indirect propagation of such audio output to a listener by reflection, except perhaps with enhanced db level.

In accordance with this understanding, prior art systems for developing perception of sound sources from different directions would necessitate the placement of a speaker along a particular orientation and at a predetermined location. In order to obtain multiple directions as part of a surround sound experience, multiple speakers (dynamic, electrostatic, parametric, etc.) at differing locations would be required. Therefore, the need to disperse speaker systems at a variety of positions within the listener's experience will generally necessitate more complex technical implementation. Speaker wires must extend from sound source to speaker hardware, or FM wireless transmission systems must be used.

For in-home theaters, retrofit of wiring may be expensive and/or detrimental to room decor. Efforts to avoid unsightly wiring may include FM wireless transmission systems which are very expensive and often problematic in operation. Even where new construction allows prewiring of surround sound systems, limited adaptability exists because the speakers are fixed at certain locations, and are not subject to rapid relocation consonant with desired changes of displacement of the sound to realize a sense of movement for the object creating the sound (car, plane, etc). If a sense of movement is desired based on shifting sound source, many speakers are generally required along the direction of movement, with complex circuitry to synchronize sound through the desired speaker devices. This fact simply increases the cost and complexity of developing more extensive surround sound systems, particularly where multiple speakers and associated wiring are required.

In addition to current trends for multidirectional sound systems, there is a clear preference for sound and speaker components which have reduced size, or are otherwise concealed. Although numerous sound systems are being developed which greatly shrink speaker dimensions for both forward and satellite speakers, the search for increased fidelity and directionality remain at odds with the trends for reduction in speaker size.

### SUMMARY OF THE INVENTION

It would be advantageous to provide a speaker which combines size reduction, placement flexibility and enhanced directional propagation of sound. Such a speaker is realized with a parametric speaker having at least two different axes of sound propagation (referred to hereafter as a biaxial speaker) in accordance with preferred embodiments of the disclosed invention. Such a speaker includes a first parametric emitter including an ultrasonic emitter having a primary direction of propagation along a first orientation and a second parametric emitter including an ultrasonic emitter having a primary direction of propagation along a second orientation. The first parametric emitter is physically coupled to the second parametric emitter such that the first and second orientations do not coincide, thereby providing for relative angular displacement of the respective first and second orientations of propagation. Electronic contacts are attached to the respective first and second parametric emitters for coupling to a parametric signal source capable of generating parametric emissions from the respective emitters which decouple in air to generate audio output along each of the respective first and second orientations.

A further embodiment of the invention is defined by first and second emitters which are physically coupled together along a common axis to provide a transverse relationship between the respective first and second orientations of propagation with respect to the common axis. A specific example includes a speaker configuration wherein the common axis is vertically oriented and positioned approximately at a midsection of each emitter such that the emitters form an X-shaped cross section. The speakers may be in a common plane or, alternatively, stacked one above the other to allow full circular rotation of either emitter.

An additional embodiment incorporates hinge structure which enables selective, relative rotation of the first parametric emitter with respect to the second parametric emitter. This speaker may include a displacement actuator coupled to the first and second emitters for enabling controlled displacement of the first and second emitters through a range of rotation. The displacement drive circuit may be coupled to the surround sound system for powering the displacement actuator in accordance with predetermined coordination signals supplied as part of the surround sound system for angularly displacing the emitters and associated parametric sound columns in a preprogrammed manner. Alternatively, angular movement of emitted sound can be accomplished by phase shifting between emitted frequencies to thereby beam steer sound propagation along different orientations.

Various positioning configurations are provided, including a speaker configuration wherein the first and second parametric emitters are positioned in front-to-back relationship, positioning the first and second orientations in opposing directions.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIGS. 1a and 1b graphically illustrate a room or other listening area typical of a surround sound environment and which includes an array of biaxial parametric speakers for supplying at least a portion of the surround sound propagation system.

FIGS. 2a and 2b show a top, plan view of the respective biaxial speakers of FIG. 1a and 1b, constructed in accordance with one embodiment of the present invention.

FIG. 3 depicts an elevated, perspective view of another embodiment of a biaxial speaker with a forward/rearward propagation orientation as shown in FIG. 1a and FIG. 1b.

FIG. 4 shows a graphic representation of another embodiment of the biaxial speaker with a rotatable propagation orientation.

FIG. 5 shows a top, plan view of a cross section of a biaxial speaker constructed in accordance with rotatable aspect of the present invention.

FIG. 6 illustrates an elevated, perspective view of a further embodiment of this invention.

FIG. 7 shows a elevated, perspective view of similar embodiment to that of FIG. 6, but with an X configuration.

### DETAILED DESCRIPTION

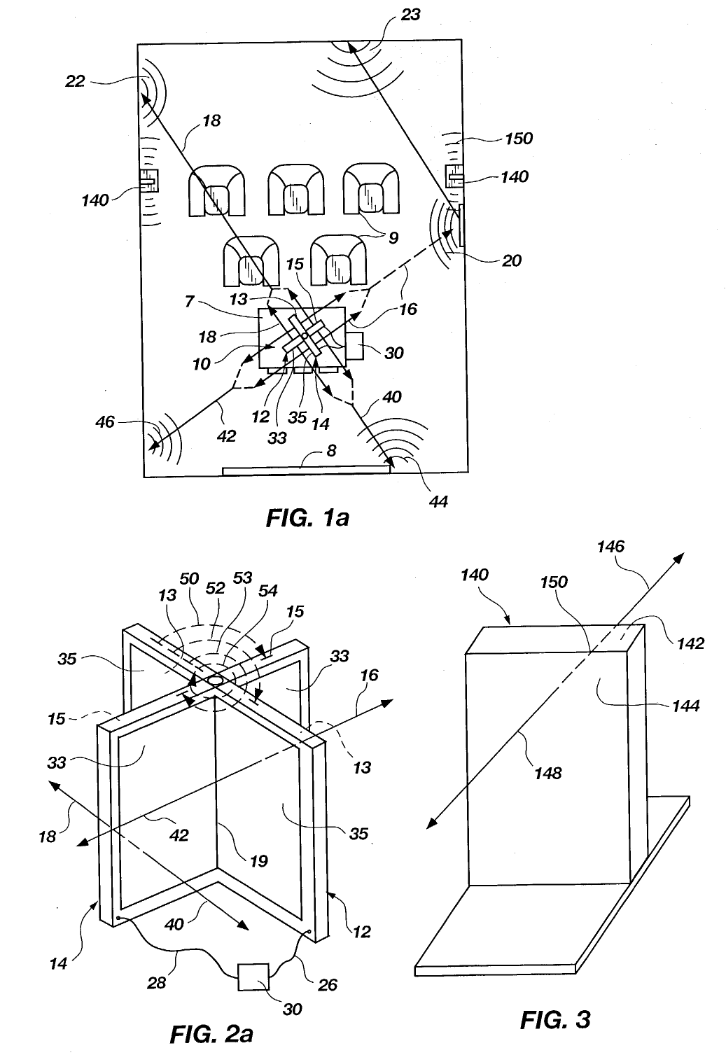

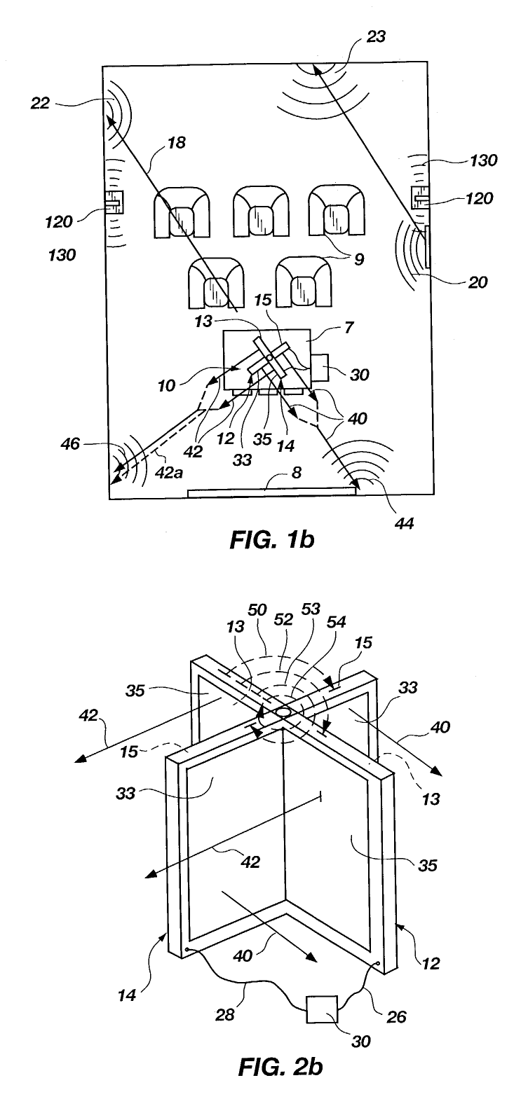

The integration of parametric speakers as part of a surround sound system offers unique advantages over prior art dynamic speakers in view of the directional character of the emitted parametric sound column, as well as its capacity for developing a virtual speaker. As used herein, a virtual speaker is a reflected sound column of parametric sound emission which facilitates a perception by a listener that sound is being generated from a virtual source at the reflective surface. This quality enables implementation of a surround sound environment without the need for actual speakers at displaced locations within the listening area. Accordingly, sound can be projected from the front of a room or other projection location toward preselected reflective surfaces such as walls, ceilings, floors, mounted plates, etc. No actual speaker device is required at these locations because the parametric sound column is projected through the air, wherein ultrasonic frequencies decouple within air as the propagating medium. The parametric sound system is designed so that at least two ultrasonic frequencies have a difference whose frequency falls within the audio bandwidth. This audio component is reflected from the remote surface, which becomes the virtual speaker for the resulting sound column. These features are illustrated in FIGS. 1 and 2 of parent U.S. Pat. No. 6,229,899 issued May 8, 2001 (T3941.CIP) and U.S. patent application Ser. No. 09/850,523 filed May 7, 2001 cited above, which are incorporated herein in their totality by reference.

Generation of parametric audio output requires two stages of conversion (for illustration see FIG. 2 as mentioned in the two cited parent applications). The first stage involves generation of the ultrasonic carrier component, with attendant modulation of the carrier with a desired audio signal to be propagated as an ultrasonic emission with sideband components representing the audio portion. This ultrasonic emission (referred to as a parametric emission) is propagated from an ultrasonic emitter into the air along a parametric sound column. The second stage of conversion occurs as the ultrasonic energy then interacts with the air molecules to decouple the audio component carried within the sidebands to develop vibration of the air molecules at audio frequencies represented by the difference between the ultrasonic frequencies. Audio output follows this second stage of conversion.

Because parametric speakers are inherently lossey due to this two-stage or double pass process, large power output typically requires a large emitter that may be a collection of numerous transducers. Typical parametric speakers configured for surround sound application in a home theater setting will have sizes in the range of 50 to 225 square inches or even larger dimensions up to 600 square inches or greater. Although a single parametric speaker could be applied to give surround sound dimension, generally at least two parametric speakers are preferred to supply the multidirectional speaker standard for servicing multiple audio channels within the simplest surround sound configuration. In view of trends to increase the number of separate channels for implementing a variety of audio effects, economy of size will likely become an even more significant issue. Accordingly, spatial requirements for the surround sound system include the various frontal audio components already provided by conventional systems, plus at least two parametric speakers, adding approximately 24 to 48 inches of speaker width or better to the conventional audio system. The present invention collapses the two parametric speakers to a width dimension as small as one of the speakers, providing a significant means for reducing speaker volume. Where more than two channels are used, multiple biaxial speakers can be implemented.

FIGS. 1a and 1b show a typical home theater configuration wherein a video projector 7 is positioned in front of a screen 8. Chairs 9 for audience members are rearward of the projector 7 and become the basis of orientation of surround sound audio effects.

FIG. 1a illustrates a preferred embodiment of a parametric speaker 10 which accomplishes size reduction by merging two emitters 12 and 14 into substantially the same volume of space which would be occupied by one parametric speaker. As shown in both a and b versions of FIGS. 1 and 2, these emitters are positioned to provide two axes of propagation 16 and 18 toward two separate virtual speakers 20 and 22. Emitter 12 with forward face 33 illustrates a configuration in which the left, forward audio channel is projected to virtual speaker 44, being the left side of the viewing audience. Rearward face 15 supplies audio projection to virtual speaker 22 behind the audience on the right side, and would therefore correspond to a right, rear channel. Similarly, emitter 14 includes a forward face 35 that would supply right, forward audio channel to virtual speaker 46, and left, rear audio channel to virtual speaker 20. Virtual speaker 20 may also provide reflection to a further virtual speaker 23 as disclosed in the parent applications.

In this embodiment, each emitter intersects part of the propagation path of the other emitter. However, because the parametric sound column is directional and the parametric conversion extends forward of the emitter face of the speaker, the sound energy is not significantly distorted by passing around the portion of the opposing emitter within the propagation path. Accordingly, this single speaker configuration is referred to as a parametric, biaxial speaker because it provides two separate parametric sound columns, propagated along two different orientations 16 and 18.

FIGS. 1b and 2b illustrate that the biaxial speaker 10 can also be configured to have single-side projection if desired. In this example, emitter face 33 is shown with two directional arrows 40 projecting on each side of intercepting emitter 12, generating the parametric audio stream toward virtual speaker 44. Similarly, emitter face 35 is shown with two directional arrows 42 projecting on each side of intercepting emitter 14, generating the parametric audio stream toward virtual speaker 46.

An additional unique benefit of the biaxial speaker with split emitter sides on the respective emitter faces is that such an emitter is well suited to implement beam steering in accordance with the parent patent applications. As shown in FIG. 1b, audio projection 42 can be actively displaced to direction 42a by phase shifting emissions progressively from one side of the emitter face to the other side of emitter face 35. Phase control circuitry can be an integrated as part of the control circuitry of the parametric speaker system represented as item 30. In this manner, the respective output channels of audio sound can be rapidly moved or adjusted, causing angular movement of the audio output along an emitted orientation directed at the audience, or shifting the locations of the virtual speaker to correspond to desired audio/visual content of the theater program. It will be apparent that these same design and performance characteristics can be implemented at rear faces of the emitters 13 and 15 as well.

In accordance with this concept, an adaptation of the biaxial speaker can include a configuration wherein at least one of the parametric emitters is divided into at least two separate sections, each powered by variable phase control circuitry coupled to the respective separate sections to enable active beam steering of at least one of the directions of propagation based on phase differentiation of emitted ultrasonic frequencies from the separate sections. In configurations as shown in FIGS. 1 and 2, the point of intersection 19 of the respective parametric emitters forms a practical separation point between emitter portions that will incorporate phase differentiation as disclosed. This combination of physical displacement of coupled parametric emitters that also includes separate phase controlled beam steering provides many options for implementing interesting audio effects, including active angular movement of the audio output along at least one of the respective first and second orientations without concurrent physical movement of the parametric emitter. Specifically, the biaxial parametric speaker comprises a first parametric emitter 12 having an ultrasonic emitter surface 13 with a primary direction of propagation along a first orientation 16, and a second parametric emitter 14 including an ultrasonic emitter surface 15 having a primary direction of propagation along a second orientation 18. The first parametric emitter 12 is physically coupled to the second parametric emitter 14 such that the first and second orientations 16 and 18 do not coincide, thereby providing a unique feature of the biaxial speaker involving a relative angular displacement of the respective first and second orientations of propagation from substantially the same volume of speaker space. Electronic contacts 26 and 28 are attached to the respective first and second parametric emitters for coupling to a parametric signal source 30 capable of generating parametric emissions from the respective emitters which decouple in air to generate audio output along each of the respective first and second orientations.

The type of parametric speaker preferred for this configuration is a film-based system in which ultrasound emissions are propagated as the film vibrates. Typically, each parametric speaker will include a number of ultrasonic emitter elements as has been discussed is the parent applications. A technical description of exemplary film emitters useful as part of a parametric speaker is disclosed in international patent application PCT/US99/19580, incorporated herein by reference. Specific reference is directed to an embodiment in which the vibratable diaphragm film is supported on a perforated plate, with emitter portions of the diaphragm drawn into perforation openings in the plate by an applied vacuum to form small, arcuate emitter sections. With film comprised of PVDF composition, the applied parametric signal voltage contacts the arcuate sections in a manner such that ultrasonic compression waves are propagated into surrounding air, forming a parametric sound column. It will be apparent that many other forms of ultrasonic emitter sources could be applied generate the desired parametric effect.

Further economies of space for the speaker can be realized by providing ultrasonic emitter faces 33 and 35 on opposing sides of the emitters 12 and 14 respectively. These additional emitter faces provide propagation of parametric sound columns 42 and 40 in opposite directions to the previously mentioned propagation directions 16 and 18. Based on this configuration, four columns of parametric sound can be generated from the same spacial volume which would typically be occupied by a single parametric speaker. Accordingly, four virtual speaker locations 20, 22, 44 and 46 can be operated around a room perimeter from a single location using substantially the same volume of space required for a single virtual speaker. All emitter faces can be driven by a single source 30 having four independent circuits capable of applying a desired parametric signal to each emitter.

In addition to varying locations of the respective virtual speakers, different bandwidths of the audio output can be allocated to different emitters to realize various desired effects. For example, the bandwidths of the first 15 and 17 second emitters can be approximately matched to provide a common range of audio output frequencies for virtual speakers 20 and 22. When implemented as part of a surround sound system, these speakers would typically operate in the higher audio frequencies, providing greater directional perception by the listener with respect to side and rearward orientations. Opposing emitters 33 and 35 which generate virtual speakers 44 and 46 having forward locations would typically operate at lower frequencies where less directivity is required. Obviously, all speakers could be allocated to higher frequencies to enable high directional perception at all perimeter locations. Various combinations of frequency allocations can be implemented as desired.

A further variation of the present biaxial parametric speaker involves displacement of the emitter faces to variable orientations, thereby changing the locations of the respective virtual speakers at perimeter walls or other reflecting surfaces, as well as reorienting propagation directions when pointed directly at an audience. Generally, this relative displacement between the respective first and second orientations is between a minimal effective angular separation of 90 degrees to a maximum angular separation of approximately 360 degrees. Examples of these orientations are represented by propagation directions 50 at 90 degrees, 52 at 180 degrees, 53 at 270 degrees and 54 corresponding to 360 degrees. Other variations include angles between these values.

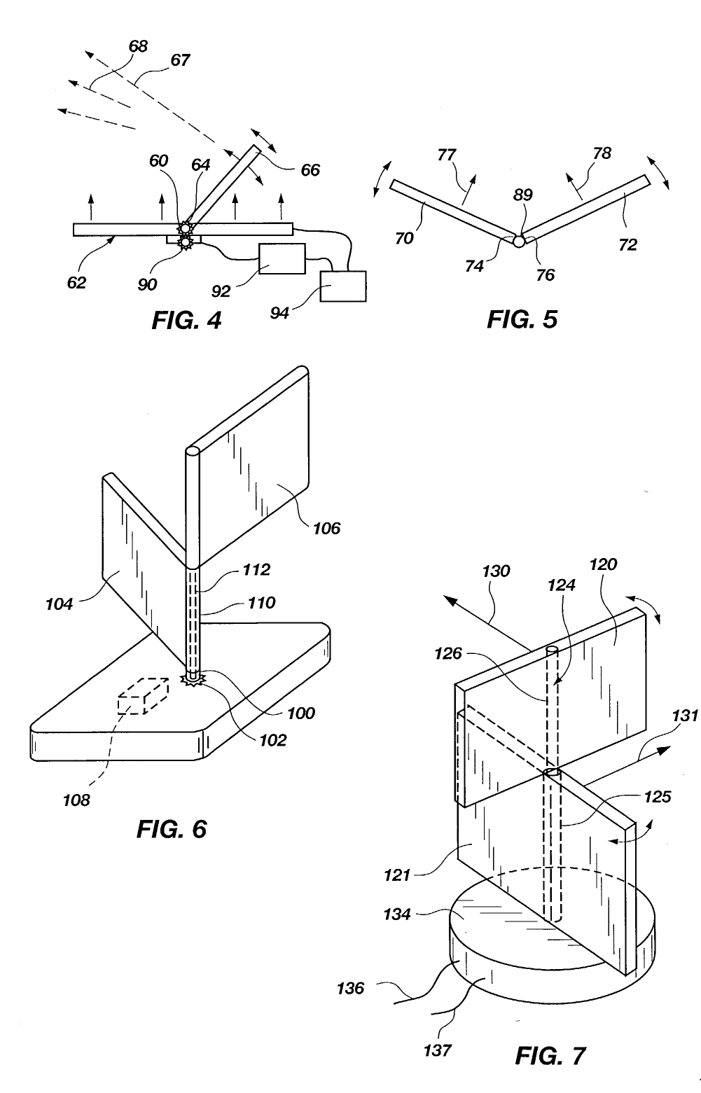

Typically, the components of the biaxial speaker are physically coupled together to maintain relative positioning between the respective emitter faces. Generally, the first and second emitters 12 and 14 have at least one straight side and are physically coupled together along the straight side as a common axis 19 to provide a transverse relationship between the respective first and second orientations of propagation 16 and 18. FIG. 4 illustrates an embodiment wherein the common axis extends along an intermediate portion 60 of one emitter 62 and at a straight side 64 and the second emitter 66. FIG. 5 shows two emitters 70 and 72 coupled at common side edges 74 and 76 to form a book-like configuration of the biaxial speaker. Two propagating orientations 77 and 78 are provided by this latter construction.

FIG. 2a depicts the preferred embodiment wherein the first and second emitters 12 and 14 are physically coupled together along a common axis 19 at an intermediate portion of both the first and second emitters. Specifically, the common axis 19 is vertically oriented and positioned approximately at a midsection of each emitter such that the emitters form an X-shaped cross section. This configuration provides minimal size and minimal interference with propagating sound because the emitter faces 13, 15, 33, and 35 are parallel with the respective directions of propagation 16, 18, 40 and 42.

A further variation of the present invention involves a modification including hinge structure 64 or 89 (FIGS. 4 and 5) which enables selective, relative rotation of the first parametric emitter with respect to the second parametric emitter. This hinge structure can be configured with the attached emitters to be capable of compression to a substantially flat configuration or extension to a full, substantially orthogonal configuration. The flat configuration is useful for storage in a protected form wherein the emitter faces are juxtaposed. FIG. 4 illustrates a first emitter member 62 coupled at an intermediate location 64 to a second emitter 66. By positioning the second emitter a different angles, variations 67 and 68 can be provided in the direction of propagation from this sound source. Movement of the second emitter is accomplished by a servo motor 90, that is coupled to a driver 92 and control circuit 94. The actual position of the second emitter can be coordinated with various desired sound effects as previously mentioned.

The hinge structure 89 of the book configuration shown in FIG. 5 may also include a displacement actuator (see FIG. 4) coupled to both the first and second emitters for enabling controlled displacement of the first and second emitters through any desired range of rotation. When integrated as part of a surround sound system, a displacement driver 92 and drive circuit 94 can be coupled to any of parametric emitters of the surround sound system for powering the displacement actuator in accordance with predetermined coordination signals supplied for angularly displacing the emitters and associated parametric sound columns in a preprogrammed manner.

FIG. 6 illustrates the use of independent displacement actuators 100 and 102 coupled telescopically to the respective first 104 and second 106 emitters, each being coupled to the displacement drive circuit 108 for providing independent adjustment of projection orientations of the parametric sound columns of the surround sound system. In this configuration, the respective emitters are rotated about a common axis 109, wherein the drive structure for rotating the emitters is coaxially positioned with a drive stem 112 for the upper emitter 106 located within the outer drive stem 110 forming part of the lower emitter 104.

It will be apparent that control circuitry 108 may be configured for alternatively supplying a parametric output signal to the first emitter 104 while disabling rotation of the second emitter 106. This concept of selective circuitry coupled to the plurality of emitters can be programmed for alternatively and successively supplying a parametric output signal to alternating emitters while disabling other emitters, to provide angular movement of sound among the propagation orientations, thereby supplying sound to a listener from time delayed, multiple directions.

FIG. 7 illustrates the concept of stacking parametric emitters 120 and 121 along a common axis 124. A pair of telescopic support stems 125 and 126 enable independent rotation of each of the emitters 120 and 121. A drive mechanism can also be coupled to these support stems as in FIG. 6, if desired. An advantage of this configuration is that full 360 degree rotation of each emitter is permitted. Furthermore, the propagation 130 and 131 of sound from each emitter is totally unobstructed. As with previous embodiments, a support base 134 houses the control circuitry, as well as drive mechanism for the emitters. Appropriate parametric signals are supplied through contacts 136 and 137.

Based on a slightly different perspective, FIG. 3 shows another embodiment of a biaxial speaker 140 wherein the first 142 and second 144 parametric emitters are positioned in front-to-back relationship, positioning the first and second orientations 146 and 148 in opposing directions. The embodiment of FIG. 3 is represented in FIG. 1 at the right side of the room, providing opposing directions which are along a common line 150 having forward and rearward sound propagation.

The advantages of this configuration over prior art dipole and bipolar loudspeakers are that it can effectively control directivity and substantially eliminate emission of acoustic energy in the plane of the emitter structure due to the parametric conversion process rather than by out-of-phase cancellation as is now common in dipole surround speakers and illustrated in co-patentee's patent U.S. Pat. No. 5,109,416 “Dipole speaker for producing ambience sound.” To restrict side radiation in the prior art it has required out-of-phase operation of the audio transducers which is wasteful in requiring the cancellation of much of the total radiated power and randomizing the phase relationships of the emitted signals which may be useful in some applications and problematic in others. If in-phase operation of the transducers is utilized, in the prior art, then the desired directivity is lost and undesirable, multiple lobes and interference patterns are generated.

With the instant invention, high directivity can be produced regardless of whether the opposing emitters are in phase or out-of-phase. Also, there are no interference patterns or inadvertent acoustic lobes generated when used in phase or out of phase. Further, there is no acoustic energy loss caused by cancellations when used in the out-of-phase mode. Further, you can achieve phase coherence AND high directivity with the in-phase connection as opposed to the prior art which either achieves high directivity OR phase coherence but not both. With the invention, directivity is achieved and freedom to choose an in-phase or out-of-phase use is possible without impacting directivity.

It is to be understood that the above-described arrangements are only illustrative of the application for the principles of the present invention. Numerous modifications and alternative arrangements can be devised without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth in the claims.

What is claimed is:

1. A biaxial parametric speaker having at least two different axes of sound propagation, said speaker comprising:
a first parametric emitter including an ultrasonic emitter surface having a primary direction of propagation along a first orientation;
a second parametric emitter including an ultrasonic emitter surface having a primary direction of propagation along a second orientation;
said first parametric emitter being physically coupled to the second parametric emitter such that the first and second orientations do not coincide, thereby providing for relative angular displacement of the respective first and second orientations of propagation; and
electronic contacts attached to the respective first and second parametric emitters for coupling to a parametric signal source capable of generating parametric emissions from the respective emitters which decouple in air to generate audio output along each of the respective first and second orientations.

2. A speaker as defined in claim 1, wherein bandwidths of the first and second emitters are approximately matched to provide a common range of audio output frequencies.

3. A speaker as defined in claim 1, wherein bandwidth of the first emitter conforms to a lower frequency range of the audio output and the bandwidth of the second emitter conforms to a higher frequency range of the audio output.

4. A speaker as defined in claim 1, wherein the relative displacement between the respective first and second orientations is between a minimal effective angular separation of approximately 90 degrees to a maximum angular separation of approximately 360 degrees.

5. A speaker as defined in claim 1, wherein the first and second emitters have at least one straight side and are physically coupled together along the straight side as a common axis to provide a transverse relationship between the respective first and second orientations of propagation with respect to the common axis.

6. A speaker as defined in claim 5, wherein the common axis extends along an intermediate portion of at least one of the emitters.

7. A speaker as defined in claim 1, wherein the first and second emitters are physically coupled together along a common axis along an intermediate portion of both the first and second emitters.

8. A speaker as defined in claim 7, wherein the common axis is vertically oriented and positioned approximately at a midsection of each emitter such that the emitters form an X-shaped cross section.

9. A speaker as defined in claim 8, wherein the common axis includes hinge structure which enables selective, relative rotation of the first parametric emitter with respect to the second parametric emitter.

10. A speaker as defined in claim 9, wherein the hinge structure with attached emitters is capable of alternative displacement to a substantially flat configuration or extension to a full, substantially orthogonal configuration.

11. A speaker as defined in claim 9, further comprising a displacement actuator coupled to the first and second emitters for enabling controlled displacement of the first and second emitters through a range of rotation.

12. A speaker as defined in claim 1, wherein the emitters are coupled within a surround sound system for providing multidirectional sound reflections from surrounding reflective surfaces which redirect sound from parametric sound columns emanating from the respective emitters.

13. A speaker as defined in claim 12, further comprising a displacement actuator coupled to at least one of the first and second emitters for enabling controlled angular displacement of sound projection of at least one audio component of the surround sound system.

14. A speaker as defined in claim 13, further comprising a displacement drive circuit coupled to the surround sound system for powering the displacement actuator in accordance with predetermined coordination signals supplied as part of the surround sound system for angularly displacing the emitters and associated parametric sound columns in a preprogrammed manner.

15. A speaker as defined in claim 14, further comprising separate, independent displacement actuators coupled to the respective first and second emitters, each being coupled to the displacement drive circuit for providing independent adjustment of projection orientations of the parametric sound columns of the surround sound system.

16. A speaker as defined in claim 1, further comprising control circuitry for alternatively supplying a parametric output signal to the first emitter while disabling the second emitter.

17. A speaker as defined in claim 1, further comprising a plurality of biaxial parametric speakers for supplying multiple orientations of sound propagation from reflective surfaces, said plurality of biaxial speakers being integrated as part of a surround sound system.

18. A speaker as defined in claim 17, further comprising control circuitry coupled to the plurality of emitters for alternatively and successively supplying a parametric output signal to alternating emitters while disabling other emitters, to provide angular movement of sound among the propagation orientations, thereby supplying sound to a listener from time delayed, multiple directions.

19. A speaker as defined in claim 1, wherein the first and second parametric emitters are positioned in front-to-back relationship, positioning the first and second orientations in opposing directions.

20. A speaker as defined in claim 19, wherein the opposing directions are along a common line having forward and rearward sound propagation.

21. A speaker as defined in claim 1, wherein at least one of the parametric emitters has a surface area between the range of approximately 10 square inches to approximately 400 square inches.

22. A speaker as defined in claim 1, wherein the respective parametric emitters are coupled to different audio channels of a surround sound system.

23. A speaker as defined in claim 1, wherein at least one of the parametric emitters is divided into at least two separate sections and further including variable phase control circuitry coupled to the respective separate sections to enable active beam steering of at least one of the directions of propagation based on phase differentiation of emitted ultrasonic frequencies from the separate sections, thereby enabling active angular movement of the audio output along at least one of the respective first and second orientations without concurrent physical movement of the parametric emitter.
